(19) United States
(12) Patent Application Publication
(10) Pub. No.: US 2023/0389566 A1
(43) Pub. Date: Dec. 7, 2023

(54) MULTICOLORED HAWTHORN POLYPHENOL LOW-SUGAR SOFT SWEET AND PREPARATION METHOD THEREOF

(71) Applicant: Hebei Normal University of Science & Technology, Qinhuangdao, Hebei Province (CN)

(72) Inventors: Suwen Liu, Qinhuangdao, Hebei (CN); Xinfang Wang, Qinhuangdao, Hebei Province (CN); Xuedong Chang, Qinhuangdao, Hebei Province (CN); Runfeng Li, Qinhuangdao, Hebei Province (CN); Siyi Pan, Qinhuangdao, Hebei Province (CN)

(21) Appl. No.: 18/033,485

(22) PCT Filed: Sep. 26, 2022
(86) PCT No.: PCT/CN2022/121255

§ 371 Date: Apr. 24, 2023

(30) Foreign Application Priority Data
Sep. 26, 2021 (CN) 202111129066.7

(51) Int. Cl. A23G 3/48; A23G 3/44; A23G 3/42; A23G 3/36

(52) U.S. Cl. CPC A23G 3/48; A23G 3/366; A23G 3/42; A23G 3/44

(57) ABSTRACT

The present disclosure provides a multicolored hawthorn polyphenol low-sugar soft sweet, comprising the following raw materials: 58 g to 62 g of a hawthorn puree, 6 g to 8 g of xylitol, 4 mg to 5 mg of hawthorn polyphenol, 5.0 g±0.5 g of gelatin, 0.3 g±0.1 g of agar, and a hawthorn fruit vinegar powder, the hawthorn fruit vinegar powder is added to allow a sugar-acid ratio of the multicolored hawthorn polyphenol low-sugar soft sweet to be (27-30):1. A preparation method thereof includes the following steps of: weighing, mashing, freezing, and thawing hawthorn pulp and/or peel, boiling with water for 9 min to 21 min, and conducting filtering to obtain the hawthorn puree; adding the xylitol to the hawthorn puree, boiling, adding the gelatin and the agar, and concentrating; after cooling, adding the hawthorn fruit vinegar powder, and stirring evenly; recooling, adding the hawthorn polyphenol, and stirring evenly to obtain a juice; and subjecting the juice to deposit forming, coagulation, refrigerating forming and drying to obtain the multicolored hawthorn polyphenol low-sugar soft sweet. The multicolored hawthorn soft sweets are suitable for the taste of the public due to the characteristics of attractive color (no pigment added), antioxidation, low sugar, excellent elasticity, high transparency, and sour and sweet flavor.

### CROSS REFERENCE TO RELATED APPLICATION

The present application claims priority to Chinese Patent Application No. 202111129066.7 filed to the China National Intellectual Property Administration (CNIPA) on Sep. 26, 2021 and entitled “MULTICOLORED HAWTHORN POLYPHENOL LOW-SUGAR SOFT SWEET AND PREPARATION METHOD THEREOF”, which is incorporated herein by reference in its entirety.

### TECHNICAL FIELD

The present disclosure relates to the technical field of hawthorn candies, in particular to a multicolored hawthorn polyphenol low-sugar soft sweet and a preparation method thereof.

### BACKGROUND

Gelatin soft sweet refers to a gelatinous candy that uses gelatin as a gelling agent. The gelatin soft sweet has excellent elasticity, high transparency, and easy digestion, and has always been favored by consumers. The existing soft sweet products all use sucrose as a sweetener, which is not suitable for some people. Xylitol is chosen as a substitute for sucrose to lower blood lipids and prevent wisdom teeth. A plurality of soft sweets on the market contain additives such as artificial colors and flavorings, which have low nutritional value and are harmful to human health. Therefore, it is urgent to need high-quality low-sugar soft sweets on the soft sweet market to meet the needs of consumers.

Hawthorn is a traditional Chinese medicinal material and a food material. As a food, the sweet and sour hawthorn can supplement a plurality of nutrient elements and promote appetite. As a medicinal material, the hawthorn has been included in the long-term development of Chinese pharmacology and in the pharmacological studies from a plurality of European countries. Hawthorn is rich in phenolic acids, polyphenols, flavonoids, polysaccharides and other functional components, showing a plurality of biological activities such as antioxidant, lipid-lowering, anti-tumor, and anti-aging activity. Hawthorn polyphenol itself is brownish red, has antioxidant, preservation, color fixing, and flavoring effects on soft sweets; and can eliminate the sour aftertaste of the soft sweet and make the taste sweeter.

Therefore, it is a technical problem urgently to be solved by those skilled in the art to provide a multicolored hawthorn polyphenol low-sugar soft sweet to replace the gelatin soft sweets on the market.

### SUMMARY

In view of this, the present disclosure provides a multicolored hawthorn polyphenol low-sugar soft sweet and a preparation method thereof. The resulting multicolored hawthorn polyphenol low-sugar soft sweet is suitable for the taste of the public due to attractive color, antioxidation, low sugar, excellent elasticity, high transparency, and sour and sweet flavor.

In order to achieve the above objective, the present disclosure adopts the following technical solutions:

A multicolored hawthorn polyphenol low-sugar soft sweet is provided, including the following raw materials: 58 g to 62 g of a hawthorn puree, 6 g to 8 g of xylitol, 4 mg to 5 mg of hawthorn polyphenol, 5.0 g±0.5 g of gelatin, 0.3 g±0.1 g of agar, and a hawthorn fruit vinegar powder, where the hawthorn fruit vinegar powder is added to allow a sugar-acid ratio of the multicolored hawthorn polyphenol low-sugar soft sweet to be (27-30):1.

A preparation method of a multicolored hawthorn polyphenol low-sugar soft sweet is provided, including the following steps:

step 1, weighing: weighing each of the raw materials by the mass fraction;

step 2, preparation of the hawthorn slurry: mashing, freezing, and thawing hawthorn pulp and/or peel, boiling with water for 9 min to 21 min, and conducting filtering to obtain the hawthorn puree;

step 3, concentration: adding the xylitol to the hawthorn puree obtained in step 1, boiling, adding the gelatin and the agar, and concentrating to obtain a juice concentrate;

step 4, antioxidation: cooling the juice concentrate obtained in step 2, adding the hawthorn fruit vinegar powder thereto, and stirring evenly; recooling a resulting mixture, adding the hawthorn polyphenol, and stirring evenly to obtain a juice; and

step 5, deposit forming and drying: subjecting the juice to deposit forming, coagulation, refrigerating forming and drying to obtain the multicolored hawthorn polyphenol low-sugar soft sweet.

As a preferred technical solution of the present disclosure, in step 2, the freezing may be conducted at −18° C. to −22° C. for 4 h.

As a preferred technical solution of the present disclosure, in step 2, the water may be added to the hawthorn pulp and/or peel in a volume ratio of 1:2.

As a preferred technical solution of the present disclosure, in step 3, the boiling may be conducted for 4 min to 6 min.

As a preferred technical solution of the present disclosure, in step 4, the cooling is to reduce a temperature to 45° C. to 50° C.; the adding the hawthorn fruit vinegar powder is not stopped until the sugar-acid ratio reaches (27-30):1; the recooling is to reduce a temperature to 38-40° C.

As a preferred technical solution of the present disclosure, in step 5, the coagulation may be conducted at room temperature; the refrigerating forming may be conducted at 4° C. for 2.5 h to 3.5 h; the drying is to dry at 35° C. to 40° C. for 2 h to 3 h, heat to 60° C. to 65° C. and hold for 1 h.

As can be seen from the above technical solutions, compared with the prior art, the present disclosure provides a preparation method of a multicolored hawthorn polyphenol low-sugar soft sweet. Hawthorn soft sweets of different colors are prepared by setting different ratios and boiling time of hawthorn peel or pulp raw materials. The hawthorn fruit vinegar powder is added to adjust acidity and mouthfeel, increase nutrients and realize anti-oxidation. The prepared hawthorn soft sweets are suitable for the taste of the public due to the characteristics of attractive color, antioxidation, low sugar, no pigment, natural sour taste, excellent elasticity, high transparency, and sour and sweet flavor.

Moreover, the present disclosure uses the hawthorn, the gelatin and the agar as main raw materials and the xylitol and the hawthorn polyphenol as auxiliary materials, without adding preservatives and pigments, while adding the hawthorn fruit vinegar powder to replace citric acid. Thus, the nutrition of the soft sweet can be increased, the astringency of the citric acid can be solved, and the product is moderately sweet and sour, with excellent chewiness. Xylitol is chosen as a substitute for sucrose to lower blood lipids and prevent wisdom teeth. The addition of polyphenols has antioxidant, preservation, color fixing, and flavoring effects, which eliminate the sour aftertaste of the soft sweet and improve the flavor. The hawthorn polyphenol low-sugar soft sweet with hawthorn-specific aroma and health care function enriches the variety and category of soft sweets and hawthorn products, and meets consumers' demand for low-sugar soft sweets. Compared with ordinary soft sweets, the hawthorn polyphenol low-sugar soft sweets can be consumed by diabetic patients and obese people, without adding pigments, and with various colors.

### BRIEF DESCRIPTION OF THE DRAWINGS

To describe the technical solutions in the examples of the present disclosure or in the prior art more clearly, the following briefly describes the accompanying drawings required for describing the examples or the prior art. Apparently, the accompanying drawings in the following description merely show the examples of the present disclosure, and a person of ordinary skill in the art may still derive other drawings from the provided accompanying drawings without creative efforts.

FIG. 1 is a picture of real products of well-prepared multicolored hawthorn polyphenol low-sugar soft sweets provided by the present disclosure;

FIG. 2 illustrates a change in polyphenol content in the fermentation process of a hawthorn fruit vinegar powder.

### DETAILED DESCRIPTION OF THE EMBODIMENTS

The technical solutions in the examples of the present disclosure will be clearly and completely described below with reference to the accompanying drawings in the examples of the present disclosure. Apparently, the described examples are only a part of examples of the present disclosure, but not all of the examples. All other examples obtained by a person of ordinary skill in the art based on the examples of the present disclosure without creative efforts shall fall within the protection scope of the present disclosure.

The examples of the present disclosure provide a preparation method of a multicolored hawthorn polyphenol low-sugar soft sweet and a multicolored hawthorn polyphenol low-sugar soft sweet.

### EXAMPLE 1

### Preparation of Orange Hawthorn Low-Sugar Soft Sweets

### 1) Preparation of a Hawthorn Puree

Red hawthorns with smooth skin and bright color and without wormholes were selected and washed with water, and the peel was separated from the pulp. The pulp was broken, frozen at −18° C. to −22° C. for 4 h, taken out, thawed naturally, and boiled with water in a volume ratio of 1:2 for 9 min to 11 min; the orange cooked puree was filtered through a mesh screen to remove residues therein and obtain a hawthorn puree.

### 2) Preparation of Gelling Agents

5.0 g±0.5 g of gelatin was weighed, heated with 7 times the volume of water, and melted for use; 0.3 g±0.1 g of agar was weighed, soaked in 35° C.±2° C. warm water for 10 min±2 min and melted for use.

### 3) Boiling and Concentration

58 g to 62 g of hawthorn puree was weighed and boiled with 6 g to 8 g of xylitol for 4 min to 6 min; the gelatin and agar prepared in step 2) were added, and heating was stopped and a concentrate was obtained until the puree was concentrated to a soluble solid content of 58% to 62%.

### 4) Preparation of a Hawthorn Fruit Vinegar Powder

Hawthorns were pulped with water in a ratio of 1:3, hydrolyzed with 0.07% pectinase in a 40° C. water bath for 3 h, and filtered; the resulting juice was held in a 90° C. thermostatic water bath for 15 min. Yeast rehydration and activation: 5 g of active dry yeast was added to 100 mL of a sugar solution with a sugar content of 5%, stirred in a 36° C. to 38° C. water bath for 10 min, and allowed to stand for 20 min to 30 min for later use; 6% sulfurous acid was added to the hawthorn juice in a mass ratio of 1:4. The hawthorn juice was fermented at 25° C. for 18 d to 20 d. Fruit vinegar brewing: the pH value was adjusted to 3.3 to 3.7, the broth volume was 100 mL, the acetic acid bacteria inoculum size was 6%, the rotational speed of shaker was 155 r/min, the juice was fermented until the acidity was 53 g/L to 55 g/L, sterilized at 95° C. for 5 min, and filtered; at 165° C., the unblocking rate was fast, and a peristaltic pump was used for spray-drying at 5 mL/min to obtain the hawthorn fruit vinegar powder.

### 5) Preparation of A Hawthorn Polyphenol Powder

292 g to 310 g of cored hawthorns were weighed, frozen at −18° C. to −22° C. for 4 h, taken out, and thawed naturally; freezing and thawing were repeated twice, the cored hawthorns were pulped and stirred with 70% acidified ethanol (0.1% hydrochloric acid) in a ratio of 1:6 at 30° C. to allow extraction for 1 h. The extract was purified by macroporous resin and concentrated in vacuo at 40-45° C. The concentrate was frozen at −18° C. to −22° C. overnight and lyophilized at −35° C. to −45° C.

### 6) Addition of the Hawthorn Fruit Vinegar Powder and Polyphenol

As the temperature of the concentrate dropped to 45-50° C., the hawthorn fruit vinegar powder was added and stirred evenly, so that the sugar-acid ratio reached (27-30):1; at room temperature, as the temperature of the resulting concentrate dropped to 38° C. to 40° C., 4 mg to 5 mg of hawthorn polyphenol was added and stirred evenly; a concentrated puree was obtained.

### 7) Deposit Forming

The concentrated puree was subjected to deposit forming, and when the concentrated puree coagulated at room temperature, it was refrigerated in a refrigerator at about 4° C. in time for 16 h to 18 h for forming; cold-formed soft sweets were demolded, put on a clean tray, and placed in a drying oven at 35° C. to 40° C. for 2 h to 3 h. The temperature rose to 60° C. to 65° C. and held for 1 h to form hard shells on the surface of the soft sweets.

### EXAMPLE 2

### Preparation of Yellow Hawthorn Low-Sugar Soft Sweets

### 1) Preparation of a Hawthorn Puree

Red hawthorns with smooth skin and bright color and without wormholes were selected and washed with water, and the peel was separated from the pulp. The pulp was broken, frozen at −18° C. to −22° C. for 4 h, taken out, thawed naturally, and boiled with water in a volume ratio of 1:2 for 19 min to 21 min; the yellow cooked puree was filtered through a mesh screen to remove residues therein and obtain a hawthorn puree.

### 2) Preparation of Gelling Agents

5.0 g±0.5 g of gelatin was weighed, heated with 7 times the volume of water, and melted for use; 0.3 g±0.1 g of agar was weighed, soaked in 35° C.±2° C. warm water for 10 min±2 min and melted for use.

### 3) Boiling and Concentration

58 g to 62 g of hawthorn puree was weighed and boiled with 6 g to 8 g of xylitol for 4 min to 6 min; the gelatin and agar prepared in step 2) were added, and heating was stopped and a concentrate was obtained until the puree was concentrated to a soluble solid content of 58% to 62%.

### 4) Preparation of a Hawthorn Fruit Vinegar Powder

Hawthorns were pulped with water in a ratio of 1:3, hydrolyzed with 0.07% pectinase in a 40° C. water bath for 3 h, and filtered; the resulting juice was held in a 90° C. thermostatic water bath for 15 min. Yeast rehydration and activation: 5 g of active dry yeast was added to 100 mL of a sugar solution with a sugar content of 5%, stirred in a 36° C. to 38° C. water bath for 10 min, and allowed to stand for 20 min to 30 min for later use; 6% sulfurous acid was added to the hawthorn juice in a mass ratio of 1:4. The hawthorn juice was fermented at 25° C. for 18 d to 20 d. Fruit vinegar brewing: the pH value was adjusted to 3.3 to 3.7, the broth volume was 100 mL, the acetic acid bacteria inoculum size was 6%, the rotational speed of shaker was 155 r/min, the juice was fermented until the acidity was 53 g/L to 55 g/L, sterilized at 95° C. for 5 min, and filtered; at 165° C., the unblocking rate was fast, and a peristaltic pump was used for spray-drying at 5 mL/min to obtain the hawthorn fruit vinegar powder.

### 5) Preparation of a Hawthorn Polyphenol Powder

292 g to 310 g of cored hawthorns were weighed, frozen at −18° C. to −22° C. for 4 h, taken out, and thawed naturally; freezing and thawing were repeated twice, the cored hawthorns were pulped and stirred with 70% acidified ethanol (0.1% hydrochloric acid) in a ratio of 1:6 at 30° C. to allow extraction for 1 h. The extract was purified by macroporous resin and concentrated in vacuo at 40-45° C. The concentrate was frozen at −18° C. to −22° C. overnight and lyophilized at −35° C. to −45° C.

### 6) Addition of the Hawthorn Fruit Vinegar Powder and Polyphenol

As the temperature of the concentrate dropped to 45° C. to 50° C., the hawthorn fruit vinegar powder was added and stirred evenly, so that the sugar-acid ratio reached (27-30):1; at room temperature, as the temperature of the resulting concentrate dropped to 38° C. to 40° C., 4 mg to 5 mg of hawthorn polyphenol was added and stirred evenly; a concentrated puree was obtained.

### 7) Deposit Forming

The concentrated puree was subjected to deposit forming, and when the concentrated puree coagulated at room temperature, it was refrigerated in a refrigerator at about 4° C. in time for 16 h to 18 h for forming; cold-formed soft sweets were demolded, put on a clean tray, and placed in a drying oven at 35° C. to 40° C. for 2 h to 3 h. The temperature rose to 60° C. to 65° C. and held for 1 h to form hard shells on the surface of the soft sweets.

### EXAMPLE 3

### Preparation of Pink Hawthorn Low-Sugar Soft Sweets

### 1) Preparation of a Hawthorn Puree

Red hawthorns with smooth skin and bright color and without wormholes were selected and washed with water, and the peel was separated from the pulp. The pulp was broken, frozen at −18° C. to −22° C. for 4 h, taken out, and thawed naturally; the peel was boiled with water in a volume ratio of 1:2 for 9 min to 11 min; the pink cooked puree was filtered through a mesh screen to remove residues therein and obtain a hawthorn puree.

### 2) Preparation of Gelling Agents

5.0 g±0.5 g of gelatin was weighed, heated with 7 times the volume of water, and melted for use; 0.3 g±0.1 g of agar was weighed, soaked in 35° C.±2° C. warm water for 10 min ±2 min and melted for use.

### 3) Boiling and Concentration

58 g to 62 g of hawthorn puree was weighed and boiled with 6 g to 8 g of xylitol for 4 min to 6 min; the gelatin and agar prepared in step 2) were added, and heating was stopped and a concentrate was obtained until the puree was concentrated to a soluble solid content of 58% to 62%.

### 4) Preparation of a Hawthorn Fruit Vinegar Powder

Hawthorns were pulped with water in a ratio of 1:3, hydrolyzed with 0.07% pectinase in a 40° C. water bath for 3 h, and filtered; the resulting juice was held in a 90° C. thermostatic water bath for 15 min. Yeast rehydration and activation: 5 g of active dry yeast was added to 100 mL of a sugar solution with a sugar content of 5%, stirred in a 36° C. to 38° C. water bath for 10 min, and allowed to stand for 20 min to 30 min for later use; 6% sulfurous acid was added to the hawthorn juice in a mass ratio of 1:4. The hawthorn juice was fermented at 25° C. for 18 d to 20 d. Fruit vinegar brewing: the pH value was adjusted to 3.3 to 3.7, the broth volume was 100 mL, the acetic acid bacteria inoculum size was 6%, the rotational speed of shaker was 155 r/min, the juice was fermented until the acidity was 53 g/L to 55 g/L, sterilized at 95° C. for 5 min, and filtered; at 165° C., the unblocking rate was fast, and a peristaltic pump was used for spray-drying at 5 mL/min to obtain the hawthorn fruit vinegar powder.

### 5) Preparation of a Hawthorn Polyphenol Powder

292 g to 310 g of cored hawthorns were weighed, frozen at −18° C. to −22° C. for 4 h, taken out, and thawed naturally; freezing and thawing were repeated twice, the cored hawthorns were pulped and stirred with 70% acidified ethanol (0.1% hydrochloric acid) in a ratio of 1:6 at 30° C. to allow extraction for 1 h. The extract was purified by macroporous resin and concentrated in vacuo at 40° C. to 45° C. The concentrate was frozen at −18° C. to −22° C. overnight and lyophilized at −35° C. to −45° C.

### 6) Addition of the Hawthorn Fruit Vinegar Powder and Polyphenol

As the temperature of the concentrate dropped to 45° C. to 50° C., the hawthorn fruit vinegar powder was added and stirred evenly, so that the sugar-acid ratio reached (27-30):1; at room temperature, as the temperature of the resulting concentrate dropped to 38° C. to 40° C., 4 mg to 5 mg of hawthorn polyphenol was added and stirred evenly; a concentrated puree was obtained.

### 7) Deposit Forming

The concentrated puree was subjected to deposit forming, and when the concentrated puree coagulated at room temperature, it was refrigerated in a refrigerator at about 4° C. in time for 16 h to 18 h for forming; cold-formed soft sweets were demolded, put on a clean tray, and placed in a drying oven at 35° C. to 40° C. for 2 h to 3 h. The temperature rose to 60° C. to 65° C. and held for 1 h to form hard shells on the surface of the soft sweets.

### EXAMPLE 4

### Preparation of Red Hawthorn Low-Sugar Soft Sweets

### 1) Preparation of a Hawthorn Puree

Red hawthorns with smooth skin and bright color and without wormholes were selected and washed with water, and the peel was separated from the pulp. The pulp was broken, frozen at −18° C. to −22° C. for 4 h, taken out, and thawed naturally; the peel was boiled with water in a volume ratio of 1:2 for 19 min to 21 min; the red cooked puree was filtered through a mesh screen to remove residues therein and obtain a hawthorn puree.

### 2) Preparation of Gelling Agents

5.0 g±0.5 g of gelatin was weighed, heated with 7 times the volume of water, and melted for use; 0.3 g±0.1 g of agar was weighed, soaked in 35° C.±2° C. warm water for 10 min ±2 min and melted for use.

### 3) Boiling and Concentration

58 g to 62 g of hawthorn puree was weighed and boiled with 6 g to 8 g of xylitol for 4 min to 6 min; the gelatin and agar prepared in step 2) were added, and heating was stopped and a concentrate was obtained until the puree was concentrated to a soluble solid content of 58% to 62%.

### 4) Preparation of a Hawthorn Fruit Vinegar Powder

Hawthorns were pulped with water in a ratio of 1:3, hydrolyzed with 0.07% pectinase in a 40° C. water bath for 3 h, and filtered; the resulting juice was held in a 90° C. thermostatic water bath for 15 min. Yeast rehydration and activation: 5 g of active dry yeast was added to 100 mL of a sugar solution with a sugar content of 5%, stirred in a 36° C. to 38° C. water bath for 10 min, and allowed to stand for 20 min to 30 min for later use; 6% sulfurous acid was added to the hawthorn juice in a mass ratio of 1:4. The hawthorn juice was fermented at 25° C. for 18 d to 20 d. Fruit vinegar brewing: the pH value was adjusted to 3.3 to 3.7, the broth volume was 100 mL, the acetic acid bacteria inoculum size was 6%, the rotational speed of shaker was 155 r/min, the juice was fermented until the acidity was 53 g/L to 55 g/L, sterilized at 95° C. for 5 min, and filtered; at 165° C., the unblocking rate was fast, and a peristaltic pump was used for spray-drying at 5 mL/min to obtain the hawthorn fruit vinegar powder.

### 5) Preparation of a Hawthorn Polyphenol Powder

292 g to 310 g of cored hawthorns were weighed, frozen at −18° C. to −22° C. for 4 h, taken out, and thawed naturally; freezing and thawing were repeated twice, the cored hawthorns were pulped and stirred with 70% acidified ethanol (0.1% hydrochloric acid) in a ratio of 1:6 at 30° C. to allow extraction for 1 h. The extract was purified by macroporous resin and concentrated in vacuo at 40° C. to 45° C. The concentrate was frozen at −18° C. to −22° C. overnight and lyophilized at −35° C. to −45° C.

### 6) Addition of the Hawthorn Fruit Vinegar Powder and Polyphenol

As the temperature of the concentrate dropped to 45° C. to 50° C., the hawthorn fruit vinegar powder was added and stirred evenly, so that the sugar-acid ratio reached (27-30):1; at room temperature, as the temperature of the resulting concentrate dropped to 38° C. to 40° C., 4 mg to 5 mg of hawthorn polyphenol was added and stirred evenly; a concentrated puree was obtained.

### 7) Deposit Forming

The concentrated puree was subjected to deposit forming, and when the concentrated puree coagulated at room temperature, it was refrigerated in a refrigerator at about 4° C. in time for 16 h to 18 h for forming; cold-formed soft sweets were demolded, put on a clean tray, and placed in a drying oven at 35° C. to 40° C. for 2-3 h. The temperature rose to 60° C. to 65° C. and held for 1 h to form hard shells on the surface of the soft sweets.

### EXAMPLE 5

### Preparation of Brown Hawthorn Low-Sugar Soft Sweets

### 1) Preparation of a Hawthorn Puree

Red hawthorns with smooth skin and bright color and without wormholes were selected and washed with water, and the peel was separated from the pulp. The pulp was broken, frozen at −18° C. to −22° C. for 4 h, taken out, and thawed naturally; red hawthorns were boiled with water in a volume ratio of 1:1 for 19 min to 21 min; the brown cooked puree was filtered through a mesh screen to remove residues therein and obtain a hawthorn puree.

### 2) Preparation of Gelling Agents

5.0 g±0.5 g of gelatin was weighed, heated with 7 times the volume of water, and melted for use; 0.3 g±0.1 g of agar was weighed, soaked in 35° C.±2° C. warm water for 10 min ±2 min and melted for use.

### 3) Boiling and Concentration

58 g to 62 g of hawthorn puree was weighed and boiled with 6 g to 8 g of xylitol for 4 min to 6 min; the gelatin and agar prepared in step 2) were added, and heating was stopped and a concentrate was obtained until the puree was concentrated to a soluble solid content of 58% to 62%.

### 4) Preparation of a Hawthorn Fruit Vinegar Powder

Hawthorns were pulped with water in a ratio of 1:3, hydrolyzed with 0.07% pectinase in a 40° C. water bath for 3 h, and filtered; the resulting juice was held in a 90° C. thermostatic water bath for 15 min. Yeast rehydration and activation: 5 g of active dry yeast was added to 100 mL of a sugar solution with a sugar content of 5%, stirred in a 36° C. to 38° C. water bath for 10 min, and allowed to stand for 20 min to 30 min for later use; 6% sulfurous acid was added to the hawthorn juice in a mass ratio of 1:4. The hawthorn juice was fermented at 25° C. for 18 d to 20 d. Fruit vinegar brewing: the pH value was adjusted to 3.3 to 3.7, the broth volume was 100 mL, the acetic acid bacteria inoculum size was 6%, the rotational speed of shaker was 155 r/min, the juice was fermented until the acidity was 5355 g/L, sterilized at 95° C. for 5 min, and filtered; at 165° C., the unblocking rate was fast, and a peristaltic pump was used for spray-drying at 5 mL/min to obtain the hawthorn fruit vinegar powder.

### 5) Preparation of a Hawthorn Polyphenol Powder

292 g to 310 g of cored hawthorns were weighed, frozen at −18° C. to −22° C. for 4 h, taken out, and thawed naturally; freezing and thawing were repeated twice, the cored hawthorns were pulped and stirred with 70% acidified ethanol (0.1% hydrochloric acid) in a ratio of 1:6 at 30° C. to allow extraction for 1 h. The extract was purified by macroporous resin and concentrated in vacuo at 40° C. to 45° C. The concentrate was frozen at −18° C. to −22° C. overnight and lyophilized at −35° C. to −45° C.

### 6) Addition of the Hawthorn Fruit Vinegar Powder and Polyphenol

As the temperature of the concentrate dropped to 45° C. to 50° C., the hawthorn fruit vinegar powder was added and stirred evenly, so that the sugar-acid ratio reached (27-30):1; at room temperature, as the temperature of the resulting concentrate dropped to 38° C. to 40° C., 4 mg to 5 mg of hawthorn polyphenol was added and stirred evenly; a concentrated puree was obtained.

### 7) Deposit Forming

The concentrated puree was subjected to deposit forming, and when the concentrated puree coagulated at room temperature, it was refrigerated in a refrigerator at about 4° C. in time for 16 h to 18 h for forming; cold-formed soft sweets were demolded, put on a clean tray, and placed in a drying oven at 35° C. to 40° C. for 2 h to 3 h. The temperature rose to 60° C. to 65° C. and held for 1 h to form hard shells on the surface of the soft sweets.

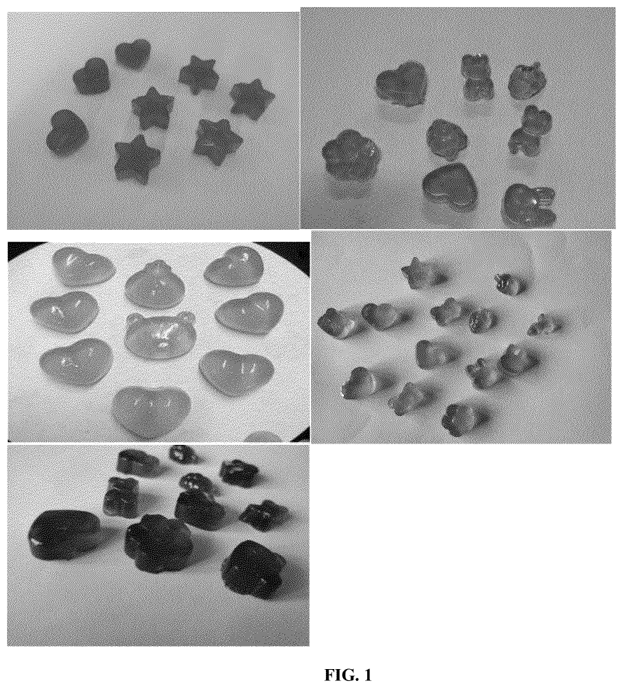

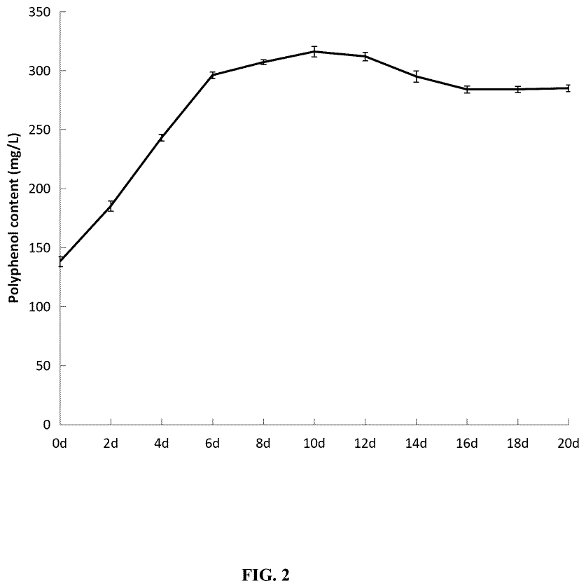

The properties of the soft sweets prepared in Examples 1 to 5 are shown in Table 1; the prepared soft sweets are shown in FIG. 1, and the changes in polyphenol content in the fermentation process of the hawthorn fruit vinegar powder are shown in FIG. 2.

TABLE 1
Texture determination results of soft sweets

| Sample | Hardness | Chewiness | Elasticity | Gumminess |
|---|---|---|---|---|
| Soft sweets (yellow) | 2.100 ± 0.11 | 7.6 ± 0.11 | 4.55 ± 0.06 | 2.370 ± 0.19 |
| Soft sweets (orange) | 2.383 ± 0.03 | 8.9 ± 0.22 | 4.71 ± 0.06 | 2.529 ± 0.01 |
| Soft sweets (pink) | 2.202 ± 0.03 | 8.7 ± 0.22 | 4.56 ± 0.06 | 2.460 ± 0.01 |
| Soft sweets (red) | 2.109 ± 0.02 | 8.1 ± 0.06 | 4.66 ± 0.06 | 2.465 ± 0.01 |
| Soft sweets (brown) | 2.112 ± 0.01 | 8.3 ± 0.04 | 4.68 ± 0.10 | 2.571 ± 0.02 |
| QQ soft sweets | 2.414 ± 0.01 | 9.0 ± 0.08 | 4.74 ± 0.05 | 2.741 ± 0.01 |
| (Wangzai) | | | | |

After testing, the accelerated shelf life testing showed that after the product was placed at room temperature for 6 months under packaged conditions, there were no obvious changes in various indicators such as color, taste, mouthfeel, and texture; microbiological examinations conformed to the national industry standard.

Each example of the present specification is described in a progressive manner, each example focuses on the difference from other examples, and the same and similar parts between the examples may refer to each other.

The above illustration of the disclosed examples can enable a person skilled in the art to implement or practice the present disclosure. Various modifications to these examples are readily apparent to a person skilled in the art, and the generic principles defined herein may be practiced in other examples without departing from the spirit or scope of the disclosure. Thus, the disclosure is not limited to the examples shown herein but falls within the widest scope consistent with the principles and novel features disclosed herein.

1. A multicolored hawthorn polyphenol low-sugar soft sweet, comprising the following raw materials by mass fraction: 58 g to 62 g of a hawthorn puree, 6 g to 8 g of xylitol, 4 mg to 5 mg of hawthorn polyphenol, 5.0 g±0.5 g of gelatin, 0.3 g±0.1 g of agar, and a hawthorn fruit vinegar powder; wherein the hawthorn fruit vinegar powder is added to allow a sugar-acid ratio of the multicolored hawthorn polyphenol low-sugar soft sweet to be (27-30):1.

2. The multicolored hawthorn polyphenol low-sugar soft sweet according to claim 1, wherein a preparation method of the hawthorn fruit vinegar powder comprises:
pulping hawthorns with water in a ratio of 1:3, hydrolyzing with 0.07% pectinase in a 40° C. water bath for 3 h, and conducting filtering; holding a resulting juice in a 90° C. thermostatic water bath for 15 min to obtain a hawthorn juice;
carrying out yeast rehydration and activation by adding 5 g of active dry yeast to 100 mL of a sugar solution with a sugar content of 5%, stirring in a 36° C. to 38° C. water bath for 10 min, and allowing to stand for 20 min to 30 min for later use;
adding 6% sulfurous acid to the hawthorn juice in a mass ratio of 1:4, and fermenting the hawthorn juice at 25° C. for 18 d to 20 d;
carrying out fruit vinegar brewing by adjusting a pH value to 3.3 to 3.7; under a broth volume of 100 mL, an acetic acid bacteria inoculum size of 6%, a rotational speed of a shaker of 155 r/min, fermenting the juice until an acidity is 53-g/L to 55 g/L, sterilizing at 95° C. for 5 min, and conducting filtering; at 165° C., under a high unblocking rate, and, conducting spray-drying using a peristaltic pump at 5 mL/min to obtain the hawthorn fruit vinegar powder.

3. The multicolored hawthorn polyphenol low-sugar soft sweet according to claim 1, wherein a preparation method of the hawthorn polyphenol comprises:
freezing 292 g to 310 g of cored hawthorns at −18° C. to −22° C. for 4 h, taking out, and thawing naturally; repeating freezing and thawing twice, pulping the cored hawthorns and stirring with 70% acidified ethanol in a ratio of 1:6 at 30° C. to allow extraction for 1 h;
purifying an obtained extract by macroporous resin and concentrating in vacuo at 40° C. to freezing a resulting concentrate at −18° C. to −22° C. overnight, and lyophilizing at −35° C. to −45° C. to obtain the hawthorn polyphenol.

4. A preparation method of the multicolored hawthorn polyphenol low-sugar soft sweet according to claim 1, comprising the following steps:
step 1, weighing each of the raw materials by the mass fraction;
step 2, preparing a hawthorn slurry by mashing, freezing, and thawing hawthorn pulp and/or peel, boiling with water for 9 min to 21 min, and conducting filtering to obtain the hawthorn puree;
step 3, carrying out concentration by adding the xylitol to the hawthorn puree obtained in step 1, boiling, adding the gelatin and the agar, and concentrating to obtain a juice concentrate;
step 4, carrying out antioxidation by cooling the juice concentrate obtained in step 2, adding the hawthorn fruit vinegar powder thereto, and stirring evenly; recooling a resulting mixture, adding the hawthorn polyphenol, and stirring evenly to obtain a juice; and
step 5, permitting deposit forming and drying lay subjecting the juice to deposit forming, coagulation, refrigerating forming and drying to obtain the multicolored hawthorn polyphenol low-sugar soft sweet.

5. The preparation method according to claim 4, wherein in step 2, the freezing is conducted at −18° C. to −22° C. for 4 h.

6. The preparation method according to claim 4, wherein in step 2, the water is added to the hawthorn pulp and/or peel in a volume ratio of 1:2 or 1:1.

7. The preparation method according to claim 4, wherein in step 2), the boiling is conducted with the water for 11 min to 19 min.

8. The preparation method according to claim 4, wherein in step 3, the boiling is conducted for 4 min to 6 min.

9. The preparation method according to claim 4, wherein in step 3), before adding the gelatin and the agar, the gelatin is melted by heating; and the agar is immersed in warm water at 35° C.±2° C. for 10 min±2 min.

10. The preparation method according to claim 4, wherein in step 3), the concentration is conducted until a soluble solid content is 58% to 62%.

11. The preparation method according to claim 4, wherein in step 4, the cooling is to reduce a temperature to 45° C. to 50° C.; the adding of the hawthorn fruit vinegar powder is not stopped until the sugar-acid ratio reaches (27-30):1; the recooling is to reduce a temperature to 38° C. to40° C.

12. The preparation method according to claim 4, wherein in step 5, the coagulation is conducted at room temperature; the refrigerating forming is conducted at 4° C. for 2.5 h to 3.5 h or 16 h to 16 h; the drying is to dry at 35° C. to 40° C. for 2 h to 3 h, heat to 60° C. to 65° C. and hold for 1 h.

13. The preparation method according to claim 4, wherein the hawthorn fruit vinegar powder is prepared according to a method that comprises:
pulping hawthorns with water in a ratio of 1:3, hydrolyzing with 0.07% pectinase in a water bath for 3 h, and conducting filtering; holding a resulting juice in a 90° C. thermostatic water bath for 15 min to obtain a hawthorn juice;
carrying out yeast rehydration and activation by adding 5 g of active dry yeast to 100 mL of a sugar solution with a sugar content of 5%, stirring in a 36° C. to 38° C. water bath for 10 min, and allowing to stand for 20 min to 30 min for later use;
adding 6% sulfurous acid to the hawthorn juice in a mass ratio of 1:4, and fermenting the hawthorn juice at 25° C. for 18 d to 20 d;
carrying out fruit vinegar brewing by adjusting a pH value to 3.3 to 3.7; under a broth volume of 100 mL, an acetic acid bacteria inoculum size of 6%, a rotational speed of a shaker of 155 r/min, fermenting the juice until an acidity is 53 g/L-55 g/L, sterilizing at for 5 min, and conducting filtering; at 165° C., under a high unblocking rate, and, conducting spray-drying using a peristaltic pump at 5 mL/min to obtain the hawthorn fruit vinegar powder.

14. The preparation method according to claim 4, wherein the hawthorn polyphenol is prepared according to a method that comprises:
freezing 292 g to 310 g of cored hawthorns at −18° C. to −22° C. for 4 h, taking out, and thawing naturally; repeating freezing and thawing twice, pulping the cored hawthorns and stirring with 70% acidified ethanol in a ratio of 1:6 at 30° C. to allow extraction for 1 h;
purifying an obtained extract by macroporous resin and concentrating in vacuo at 40° C. to freezing a resulting concentrate at −18° C. to −22° C. overnight, and lyophilizing at −35° C. to −45° C. to obtain the hawthorn polyphenol.

15. The preparation method according to claim 13, wherein in step 2, the freezing is conducted at −18° C. to −22° C. for 4 h.

16. The preparation method according to claim 14, wherein in step 2, the freezing is conducted at −18° C. to −22° C. for 4 h.

17. The preparation method according to claim 13, wherein in step 2, the water is added to the hawthorn pulp and/or peel in a volume ratio of 1:2 or 1:1.

18. The preparation method according to claim 14, wherein in step 2, the water is added to the hawthorn pulp and/or peel in a volume ratio of 1:2 or 1:1.

19. The preparation method according to claim 13, wherein in step 2), the boiling is conducted with the water for 11 min to 19 min.

20. The preparation method according to claim 14, wherein in step 2), the boiling is conducted with the water for 11 min to 19 min.
